(19) United States
(12) Patent Application Publication
(10) Pub. No.: US 2016/0189188 A1
(43) Pub. Date: Jun. 30, 2016

(54) DYNAMIC PRICING BASED ON TRANSACTION MODELS

(71) Applicant: Verizon Patent and Licensing Inc., Arlington, VA (US)

(72) Inventors: Chris L. White, Dallas, TX (US); Jyothish S. Pillai, Irving, TX (US); Bijith Moopen, Euless, TX (US); Srinivasa M. Kotaru, Plano, TX (US); Krishna K. Talluri, Ashburn, VA (US); Shashi K. Shukla, Ashburn, VA (US); Saravanan Shanmugasundaram, Ashburn, VA (US)

(21) Appl. No.: 14/583,867

(22) Filed: Dec. 29, 2014

(51) Int. Cl. G06Q 30/02

(52) U.S. Cl. CPC G06Q 30/0206

(57) ABSTRACT

A device and method may dynamically generate pricing based on transactional and right to buy pricing models. The method may include receiving a price request for a telecommunication service from a customer system, creating a price scenario for the telecommunication service based on the request, wherein the price scenario includes a plurality of line items. The method may further include deciding whether to calculate a standard price or a dynamic price for each line item, calculating a price for each of the line items in the price scenario in response to the deciding, and determining at least one price option for the price scenario. The method may further include validating the at least one price option for the price scenario, updating the price scenario with the at least one validated price option, and providing the updated price scenario to the customer system.

### BACKGROUND

Ascertaining prices for complex services and products may depend on a very large number of variables, some of which may change with time depending on fast changing markets, the entry of competitors, and/or introductions of new technologies. Determining favorable (e.g., optimal) prices, which is both competitive in the market and profitable for the provider, may involve the analysis of an extremely large number of combinations of prices for interrelated subservices and/or supporting components having overlapping feature sets and characteristics. Conventional approaches for determining such prices can be time consuming, resource intensive, and error-prone.

### BRIEF DESCRIPTION OF THE DRAWINGS

FIG. 1 is a diagram illustrating an overview of an exemplary pricing system which may perform dynamic pricing based on a transactional model;

FIG. 2 is a block diagram showing an exemplary networking environment for the pricing system;

FIG. 3 is a block diagram showing functional details of an exemplary price engine within the pricing system;

FIG. 4 is a block diagram of exemplary components of a price engine or a network device associated with a cost service, a customer pricebook service, and/or a standard price service;

FIG. 5 is flow diagram illustrating an exemplary process for generating price scenarios by the pricing system;

FIG. 6 is a flow diagram illustrating details of an exemplary process for determining price options for a price scenario;

FIG. 7 is a flow diagram illustrating details of an exemplary process for validating price options and updating the price scenario;

FIG. 8 is a flow diagram illustrating an exemplary process for performing a standard price lookup;

FIG. 9 is a flow diagram illustrating an exemplary process for creating or updating a customer pricebook; and

FIG. 10 is a flow diagram illustrating an exemplary process for setting up and administering a standard price repository which may be stored in a standard price storage device.

### DETAILED DESCRIPTION OF PREFERRED EMBODIMENTS

The following detailed description refers to the accompanying drawings. The same reference numbers in different drawings may identify the same or similar elements.

Embodiments described herein are directed to dynamically generating prices of complex products and services based on transaction models. The transaction models may include various pricing arrangements, dynamic market conditions, and pricing options which may include, for example, discounts and/or promotions. Embodiments may include End-to-End integrator (E2Ei) systems providing strategic pricing for complex services and products, such as, for example, telecommunication services and/or products. Such services may include networking access services, private Internet Protocol (IP) networking services, Voice over Internet Protocol (VoIP) services, cloud services, etc. Products may include equipment, both hardware and/or software, to support the telecommunication services. Pricing systems may assist in pricing customer deals by analyzing deal financials using configurable rules and policy constraints under varying market conditions.

As used herein, the term “transactional model” may refer to a model in which interactions in two directions are considered together, for example from one person to another and back, or from one subsystem to another and back. As used herein, the term “dynamic pricing” may refer to pricing which reflects time varying prices, costs, and pricing options for products and/or services that may change due to market forces, and may be based on statistical analyses for a market of interest associated with a particular price request. The term “standard pricing” may refer to pricing based on service and/or product catalogs, and/or prior history with a specific customer. As used herein, the term “price options” may refer one or more pricing alternatives which may include promotions, discounts, to products and services. As used herein, the term “deal financials” may refer to metrics for analyzing the results of a generated price, such as, for example, the margin, profitability, etc. The metrics may take into account various costs, including those associated with the price options. The term “price scenario” may refer to a pricing structure, provided in response to a pricing request, for services and/or products having different features, functions, and/or performance criteria, which may further include a variety of options for function and/or performance depending upon context. The price scenario may be comprised of multiple line items associated with components of the service and/or product which may facilitate the analysis and pricing in the price scenario. As used herein, the term “rate determinants” may be factors used in pricing and thus can be considered in calculating a price. Rate determinants may include price-influencing factors such as, for example, location (e.g., zip code, state, country), service/product performance such data access speed, type of product (e.g., Ethernet), known competitor's pricing, prorating, etc.

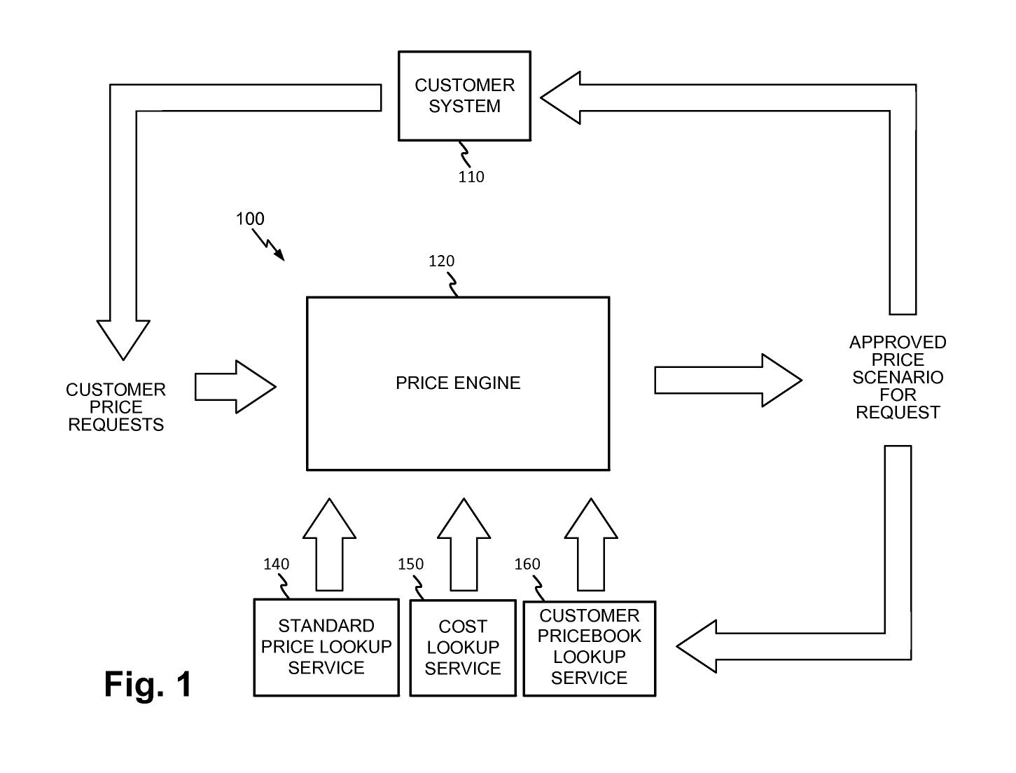

FIG. 1 is a diagram illustrating an overview of an exemplary pricing system 100 may perform dynamic pricing based on a transactional model. Pricing system 100 may include a price engine 120, a standard price lookup service 140, a cost lookup service 150, and a customer pricebook lookup service 160. Pricing system 100 may implement an integrated end-to-end solution which can provide market (i.e., dynamic) pricing using a deal based pricing approach when interacting with a customer system 110.

Price engine 120 may receive customer price requests from customer system 110. The customer price requests may be for complex services and/or products, such as, for example, telecommunication services and supporting equipment. The customer request may include metadata that may be contextual in nature. For example, metadata may include information identifying the customer, the type of price request, location information for the requested services and/or products, and/or information regarding past transaction (e.g., information identifying prior transactions). The metadata may be used by price engine 120 to validate requests and perform pricing for the customer requests. The customer price request may be created by another system which provides a solution, for example, to a telecommunications need, based on the functional and/or performance requirements of the customer. The functional and performance requirements may be generated by customer system 110 or another system associated with the service provider (not shown).

Price engine 120 may receive a price request from customer system 110 and subsequently analyze the request. The analysis results in the creation of a price scenario, which includes parsing the request into simpler subcomponents called “line items.” The line items may correspond to pricing for common subcomponents, products, or subsystems (analogous to “building blocks”) that may be used to realize the service and/or product(s) for the customer. Accordingly, different services and/or products may include common or overlapping line items. Price engine 120 may determine the price for each of the line items based upon, for example, previously defined logical constructs called “rules,” metadata in the price request, pricing and cost for services and/or products associated with the line items, and/or, if applicable, prior customer interactions when the request is associated with an existing customer. Pricing engine 120 may determine whether standard pricing or dynamic pricing may be employed for each line item in the price scenario. The prices may be determined through the rules and associated templates (described in more detail below), and may further use one or more data providing services that may be external to price engine 120. Such services, for example, may include a standard price lookup service 140 which provides data associated with standard pricing for line items; a cost lookup service 150 which provides data associated with the costs associated service and/or product features; and customer pricebook lookup service 160 which provides pricing data associated with existing customers for prior and/or existing services and/or products.

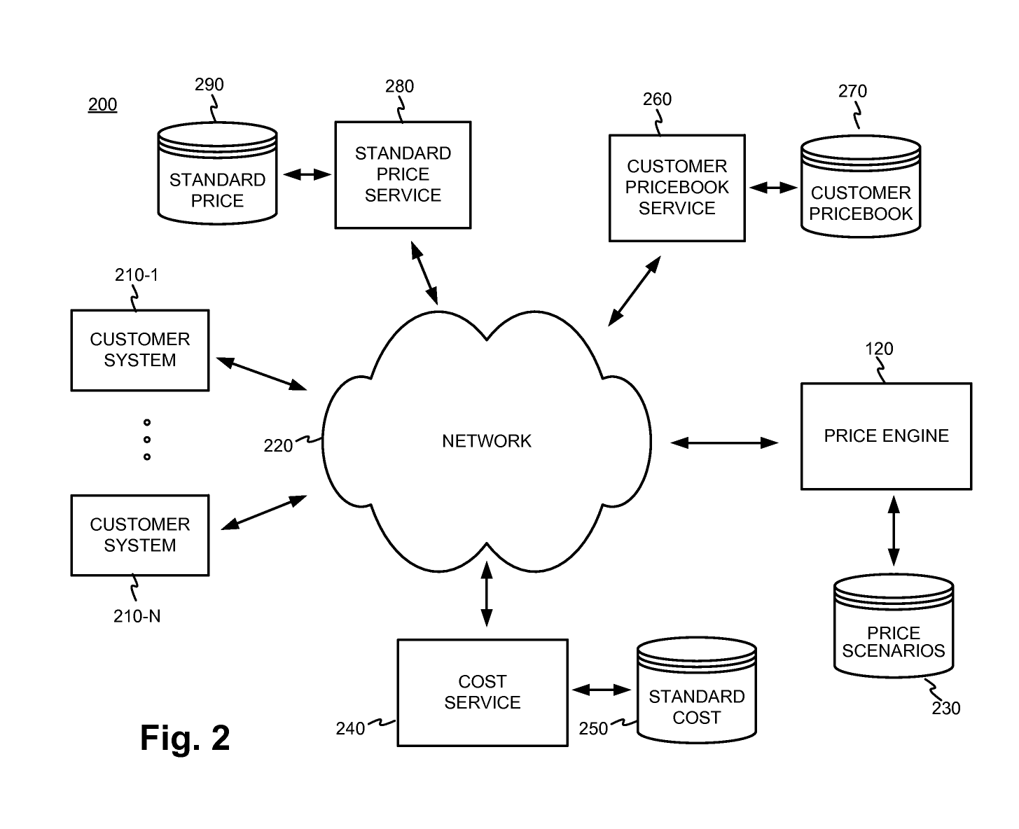

Upon determining a price for all of the line items the price scenario, price engine 120 may determine costs, credits, margins, and/or price options (e.g., promotions and/or discounts) for the price scenario. Price engine 120 may then automatically check and approve the price scenario, and/or permit a representative to manually approve the price scenario, prior to sending the price scenario to the customer system 110. Once approved, the price scenario may be provided to customer system 110 which may accept or reject the scenario. Once accepted by customer system 110, the approved price scenario may be stored (by a customer pricebook service 260 as described below in relation to FIG. 2) for future use by the customer pricebook lookup service 160.

FIG. 2 is a block diagram showing an exemplary networking environment 200 for pricing system 100. Network environment 200 may include price engine 120, customer systems 210-1, . . . , 210-N (herein referred to plurally as “customer systems 210” and individually as “customer system 210-x”), network 220, pricebook scenario storage 230, cost service 240, standard cost storage 250, customer pricebook service 260, customer pricebook storage 270, standard price service 280, and standard price storage 290. Other embodiments may include additional or different network entities in alternative configurations than those exemplified in FIG. 2. Communications between the aforementioned network entities may take place through network 220 and/or through other intermediary systems (not shown).

Customer systems 210 may obtain access to network 220 for communicating with price engine 120, to provide price requests for services and/or products, and receive approved price scenarios generated by price engine 120 in response to the price requests. Moreover, customer systems 210 may exchange information with price engine 120 (directly or indirectly), based on interactive communications or non-interactive communications. The communications may include text-based communications, forms-based communications, voice communications, etc. Price engine 120 may provide approved price scenarios to customer system 210-x, via network 220, during the interactive session (e.g., towards the end), or sometime after the interaction session is terminated.

Price engine 120 may receive customer price requests from customer systems 210 and generate price scenarios for services and/or products, such as, for example, telecommunication services and/or supporting equipment. When generating price scenarios for the pricing request, price engine 120 may use cost service 240 to determine costs, and standard price service 280 to determine prices if standard pricing is being used. Price engine may also access customer pricebook service to determine any customer specific information which may be germane in determining the price scenario (as will be discussed in more detail below). One generated, the price scenario may be sent to the requesting customer systems 210. In some embodiments, the price scenario may be initially sent to a network entity which is different from customer system 210-x that sent the price request. Additionally, the generated price scenario may also be provided to customer pricebook service 260 for placement in price scenario storage 230. Price engine 120 may be any type of network entity, server, etc. suitably configured to receive pricing request and generate and store price scenarios.

Customer systems 210 may provide interface and appropriate networking functionality for providing a customer the ability to generate a price request for services and/or products, and/or receive a price scenario in response to the price request. A customer system 210-x may include a configuration tool having an online platform (e.g., web client). Customer systems 210 may be may be any type of network entity, server, etc. suitably configured to generate a pricing request, and/or receive and/or display price scenarios. Customer systems may include an electronic device having any type of communication capabilities, and thus may communicate over network 210 using a variety of different channels, including both wired and wireless connections.

Customer systems 210 may include, for example, a cellular radiotelephone, a smart phone, a tablet, any type of Internet Protocol (IP) communications device, a Voice over Internet Protocol (VoIP) device, a laptop computer, a desktop computer, a palmtop computer, a server, or a set top box (STB).

Cost service 240 may provide services associated with costs of offered services and/or products. Cost service 240 may include administration services and cost lookup services. The administration services may create and maintain data repositories for costs associated with a large number of services and/or products offered to customers. The costs may be derived using product catalogs for services and/or products which are offered and/or for legacy products. The data repositories may be stored in standard cost storage 250. Standard cost storage 250 may be realized using databases and data storage hardware. Cost service 240 may provide the cost lookup services for a service/product feature(s) to price engine 240 so that price scenarios may be updated. Cost service 240 may hosted on any type of network entity, server, etc. suitably configured to administer and maintain cost information and provide cost lookup services for price engine 120.

Customer pricebook service 260 may provide services associated with customer specific information that may include, for example, price quotes for configurations in accordance with contracts, previously agreed upon prices, and/or price options which may include promotions and/or discounts specific to a customer.

Customer pricebook service 260 includes administration services and lookup services. For example, the administration services may create and maintain data repositories for customer specific information associated with prior transactions and/or agreements with customers. The customer specific information may be created by the customer pricebook creation service, which may store price scenarios on a line item basis, and may further include price options (e.g., promotions and/or discounts) used for updating the price scenario within price engine 120. The customer specific information may be placed in data repositories that are stored in customer pricebook storage 270. Once price scenarios are established by price engine 120, customer pricebook service 260 may be used to supply data to billing systems, thus making sure that the quoted prices, the contracted (agreed upon) prices, and the billed prices are accurate and consistent. In an embodiment, once price engine 120 determines and finalizes a price scenario for a given price request, that price scenario may be provided to the customer pricebook service for storage in customer pricebook storage 270. Billing systems may periodically obtain price scenario information for accurate billing of the customer. Customer pricebook service 260 may hosted on any type of network entity, server, etc. suitably configured to administer and maintain customer pricebook information and provide customer pricebook lookup services for price engine 120. Customer pricebook storage 270 may be realized using databases and data storage hardware. Customer pricebook service 260 may further provide customer lookup services which may be used by price engine 120 to generate future price scenarios.

Standard price service 280 may provide services associated with the standard prices of offered services and/or products. Standard price service 280 may include administration services and standard price lookup services. The administration services may create and maintain data repositories, on a line item basis, for standard prices associated with a large number of services and/or products offered to customers. The standard prices may be established and maintained from approved sources, such as, for example, catalogs for services and/or products being offered. The data repositories may be stored in standard price storage 290. Standard price storage 290 may be realized using databases and data storage hardware. Standard price service 280 may hosted on any type of network entity, server, etc. suitably configured to administer and maintain standard price information and provide standard price lookup services for price engine 120 on a line item basis.

In some embodiments, price engine 120, cost service 240, customer pricebook service 260, and/or standard price service 280 may be logical entities that can be realized in software, and may be hosted on one or more machines. In some embodiments, the host machine(s) may be shared among the aforementioned logical entities. In some embodiments, the machine(s) hosting price engine 120, cost service 240, customer pricebook service 260, and/or standard price service 280 may be realized in physical hardware and/or virtual machines.

Network 220 may be include a local area network (LAN) and a wide area network, which may be realized using wired and/or wireless networks. The wireless network may further includes one or more wireless networks of any type, such as, for example, a local area network (LAN), a wide area network (WAN), a wireless satellite network, and/or one or more wireless public land mobile networks (PLMNs). The wireless networks may include WiFi (e.g., any IEEE 802.11x network, where x=a, b, c, g, and/or n), or wireless network covering larger areas, which may include mesh networking (e.g., IEEE 802.11s) and/or or a WiMAX IEEE 802.16. The PLMN(s) may include a Code Division Multiple Access (CDMA) 2000 PLMN, a Global System for Mobile Communications (GSM) PLMN, a Long Term Evolution (LTE) PLMN and/or other types of PLMNs not specifically described herein. Network 220 may further include one or more wired networks, which may include a local area wired network, wide area networks, and/or backhaul networks, backbone networks, metro-area networks, and/or the Internet. Specifically, the wired network(s) may include a wide area network that connects back-haul networks and/or core networks, and may include a metropolitan area network (MAN), an intranet, the Internet, a cable-based network (e.g., an optical cable network), networks operating known protocols, including Asynchronous Transfer Mode (ATM), Optical Transport Network (OTN), Synchronous Optical Networking (SONET), Synchronous Digital Hierarchy (SDH), Multiprotocol Label Switching (MPLS), and/or Transmission Control Protocol/Internet Protocol (TCP/IP).

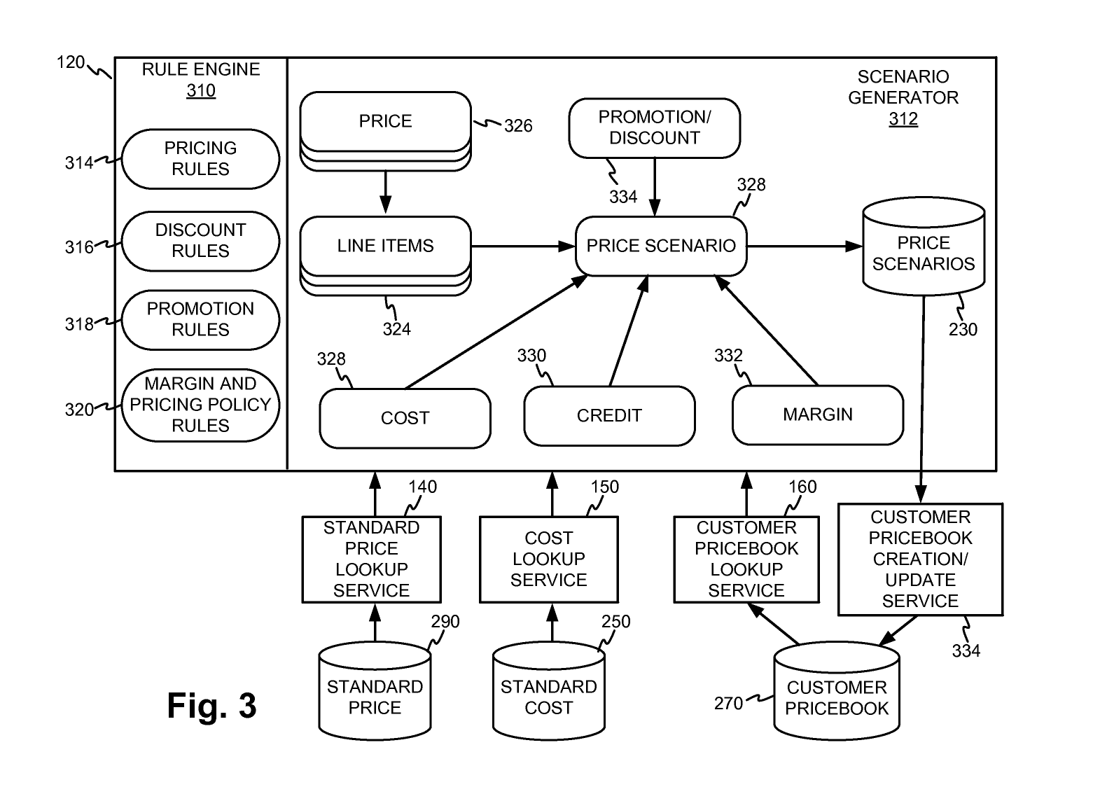

FIG. 3 is a block diagram showing functional details of an exemplary price engine 120 within pricing system 110. Pricing engine 120 may be broken down into two parts: rule engine 310 and scenario generator 312. Rule engine 310 may include rules for generating various components used in pricing. For example, rule engine 310 may include pricing rules 314 for standard and/or dynamic pricing, discount rules 316 for determining discounts, promotion rules 318 for determining promotions, and margin and pricing policy rules 320 for calculating margins and policy for pricing. Using the rules provided by rule engine 310 in conjunction with information provided by standard price lookup service 140, cost lookup service 150, and customer pricebook lookup service 160, price scenario generator 312 may create a price scenario 328. Once approved and finalized, price scenario 328 may be stored in price scenario storage 230, and may also be provided to a customer pricebook creation/administration service, where it may be stored for billing and future pricing in customer pricebook storage 270. Upon receiving a pricing request from customer system 210-x, scenario generator 312 may analyze the request and break the price scenario into a number of line items 324. For each line item, scenario generator 312 may determine price 326. Once the line items are combined into an initial price scenario, cost 328, credit 330, margin 332, and/or price options (e.g., promotions and/or discounts 334) may be applied to update the initial price scenario 328. The updated price scenario 328 may be approved internally automatically by price engine 120, and subsequently provided to the customer for approval and signature to finalize price scenario 328. The final price scenario 328 may be stored in price scenarios storage 230 and/or customer pricebook 270.

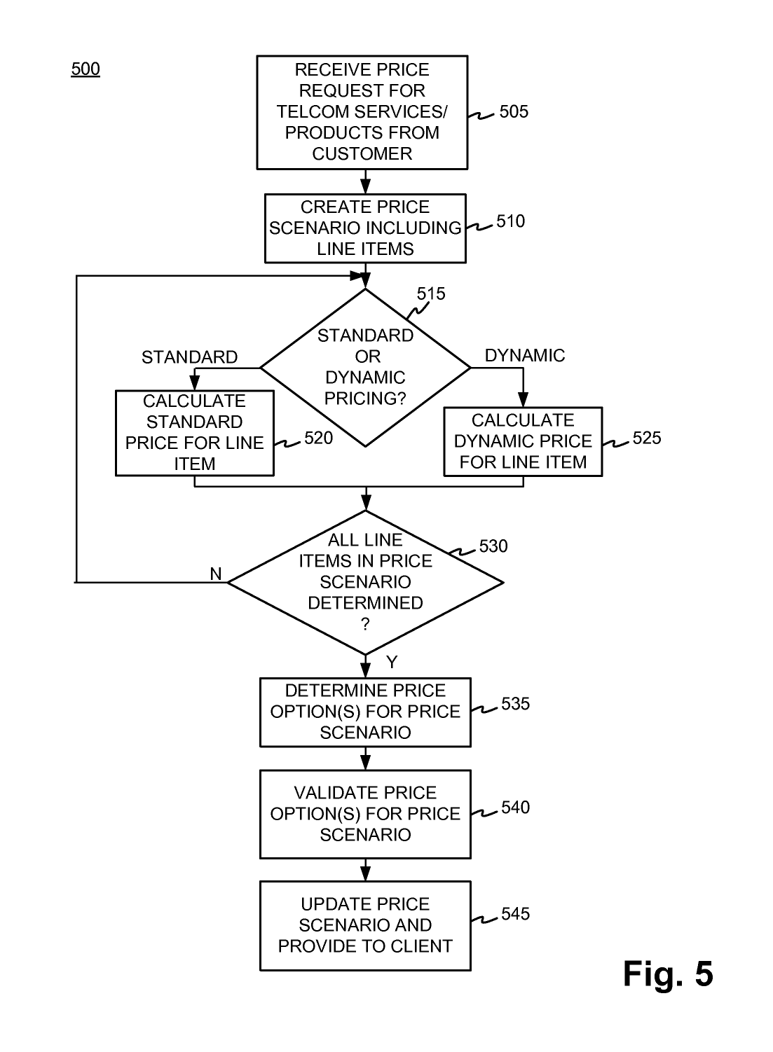

In more detail, for example, scenario generator 312 may initially determine price 326 for each line item using pricing rules 314. Depending upon metadata associated with the pricing request (as will be described in more detail below in regards to FIG. 5), either standard pricing or dynamic pricing may be used by pricing rules 314. Dynamic pricing may use separate pricing rules which may calculate prices based on market conditions, statistical measures of pricing, and other factors to generate up-to-date market-based price. Alternatively, based on the metadata in the pricing request, scenario generator 312 may price the line items based on standard pricing. The standard pricing may be performed by looking up standard prices in standard price storage 290 by standard price lookup service 140. Standard price storage 290 may include prices indexed by stock keeping unit (SKU) numbers which may be updated with the latest pricing as determined by on-line service and/or product catalogs. Alternatively or additionally, metadata in the price request may indicate that prices for services and/or products have already been agreed upon, which may be retrieved by standard price lookup service 140.

Once prices are determined for all line items for price scenario 328, cost 328 may be determined using the cost lookup service 150 based on costs stored in standard cost storage 250. The standard cost storage 250 may include updated costs on a per feature basis (according to the service and/or product) which may be determined by SKU number. Scenario generator 312 may further update the price scenario 328 by determining credit 330 and/or margin 332 based on margin and pricing policy rules 320 for price scenario 328. Additional information for credit 330 may also be determined from the customer pricebook lookup service 160 if the customer is identified as a previous customer. Price options, such as promotion and/or discounts 334, may be determined by promotion rules 318 and discount rules 316, respectively. Once determined, they may be used to update price scenario 328 to reflect the price options.

Once price scenario 328 is updated to reflect adjustments due to determined cost 328, credit 330, margin 332, promotions and/or discounts 334, price scenario may be automatically approved (or receive a manual approval from an operator), and provide price scenario 328 to customer system 210-x for approval and acceptance. Once approved and accepted by customer system 210-x, the final price scenario may be stored in price scenarios storage 230, and provided to the customer pricebook creation/update service for storage in customer pricebook storage 270

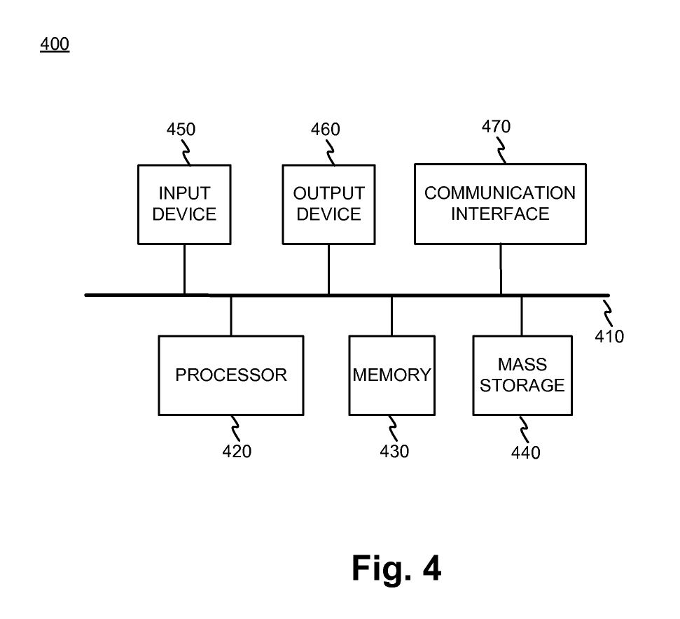

FIG. 4 is a block diagram of exemplary components of a price engine 120. Additionally, the block diagram of FIG. 4 may be used to illustrate exemplary components of one or more network device associated with cost service 240, customer pricebook service 260, and/or standard price service 280.

Price engine 120 may include a bus 410, a processor 420, a memory 430, mass storage 440, an input device 450, an output device 460, and a communication interface 470. Bus 410 includes a path that permits communication among the components of price engine 120. Processor 420 may include any type of single-core processor, multi-core processor, microprocessor, latch-based processor, and/or processing logic (or families of processors, microprocessors, and/or processing logics) that interprets and executes instructions. In other embodiments, processor 420 may include an application-specific integrated circuit (ASIC), a field-programmable gate array (FPGA), and/or another type of integrated circuit or processing logic. For example, the processor 420 may be an x86 based CPU, and may use any operating system, which may include varieties of the Windows, UNIX, and/or Linux. The processor 420 may also use high-level analysis software packages and/or custom software written in any programming and/or scripting languages for interacting with other network entities.

Memory 430 may include any type of dynamic storage device that may store information and/or instructions, for execution by processor 420, and/or any type of non-volatile storage device that may store information for use by processor 420. For example, memory 430 may include a RAM or another type of dynamic storage device, a ROM device or another type of static storage device, and/or a removable form of memory, such as a flash memory. Mass storage device 440 may include any type of on-board device suitable for storing large amounts of data, and may include one or more hard drives, solid state drives, and/or various types of RAID arrays. Mass storage device 440 would be suitable for storing files associated verifying credit card transactions.

Input device 450, which may be optional, can allow an operator to input information into price engine 120 if required. Input device 450 may include, for example, a keyboard, a mouse, a pen, a microphone, a remote control, an audio capture device, an image and/or video capture device, a touch-screen display, and/or another type of input device. In some embodiments, price engine 120 may be managed remotely and may not include input device 450. Output device 460 may output information to an operator of price engine 120. Output device 460 may include a display (such as an LCD), a printer, a speaker, and/or another type of output device. In some embodiments, price engine 120 may be managed remotely and may not include output device 460.

Communication interface 470 may include a transceiver that enables price engine 120 to communicate over network 320 with other devices and/or systems. The communications interface 470 may be a wireless communications (e.g., RF, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 470 may include a transmitter that converts baseband signals to RF signals and/or a receiver that converts RF signals to baseband signals. Communication interface 470 may be coupled to one or more antennas for transmitting and receiving RF signals. Communication interface 470 may include a logical component that includes input and/or output ports, input and/or output systems, and/or other input and output components that facilitate the transmission/reception of data to/from other devices. For example, communication interface 470 may include a network interface card (e.g., Ethernet card) for wired communications and/or a wireless network interface (e.g., a WiFi) card for wireless communications.

As described below, price engine 120 may perform certain operations relating to generating price scenarios in response to requests from customer systems 210. Price engine 120 may perform these operations in response to processor 420 executing software instructions contained in a computer-readable medium, such as memory 430 and/or mass storage 440. The software instructions may be read into memory 430 from another computer-readable medium or from another device. The software instructions contained in memory 430 may cause processor 420 to perform processes described herein. Alternatively, hardwired circuitry may be used in place of, or in combination with, software instructions to implement processes described herein. Thus, implementations described herein are not limited to any specific combination of hardware circuitry and software.

Although FIG. 4 shows exemplary components of price engine 120, in other implementations, price engine 120 may include fewer components, different components, additional components, or differently arranged components than depicted in FIG. 4.

FIG. 5 is flow diagram illustrating an exemplary process 500 for generating price scenarios 328 by pricing system 100. Process 500 may be performed by one or more components in pricing system 100, including price engine 120, standard price lookup service 140, cost lookup service 160, customer pricebook lookup service 160, and/or customer pricebook creation/update service 334. Pricing system 100 may initially receive a price request for telecommunication services and/or products from customer system 210-x (Block 505). Based on the received price request, pricing system 100 may create price scenario 328 for the telecommunication service based on the request. When creating price scenario 328, pricing system generates a line items 324 (Block 510).

For each line item 324 in price scenario 328, pricing system 100 may determine a price as shown in Blocks 515 through 530 in FIG. 5. In more detail, at Block 515, pricing system 100 may decide whether to calculate a standard price or a dynamic price for a line item 324 (Block 515). This determination may be based upon metadata included in the received price request from a customer system. The determination may be based upon using the metadata to identify a provider for a service associated with the price request service. For example, the determination may be based upon the identities of particular providers for the requested service and/or product, type of service and/or product requested, and/or the location where requested service will be rendered and/or product will be installed.

If the service and/or product for the line item is associated with a provider having information stored in standard price storage 290, pricing system 100 may determine in Block 515 that standard pricing is appropriate, and subsequently calculate a standard price for the line item 324 using standard price lookup service 140 (Block 520). Standard price lookup service 140 may determine a price based on a number of right to buy models which may be indicated as a price request type in the received price request. The price request types may include a Right to Buy (RTB), a Transaction (TX), a Quote to Order (Q2O), a Next Order (NO), and/or a Move, Change and Disconnect (MACD). The RTB may be subject to a pre-existing contract or a pre-negotiated agreement where the price was agreed upon before purchasing and receiving the price request from the customer system. The TX type may include an agreement to a price made just prior agreeing to purchase, where subsequent purchases are subject to new pricing and not therefore not “locked in” as in the RTB pricing type. The Q2O price type is similar RTB, but a new contract or agreement is established just prior to purchase, and subsequent purchases are locked in to the agreed upon price. The NxO is similar to the Q2O price type, but may be based on a preexisting contract or agreement. The MACD price type is where existing service is changed in some respect, where the services is moved to a new location or disconnected. The standard price may use specific pricing rules 314 in conjunction with lookup tables. The lookup services may include SKU based pricing and find combinations of services and products having a range of values regarding capability, performance, location, functionality, and pricing.

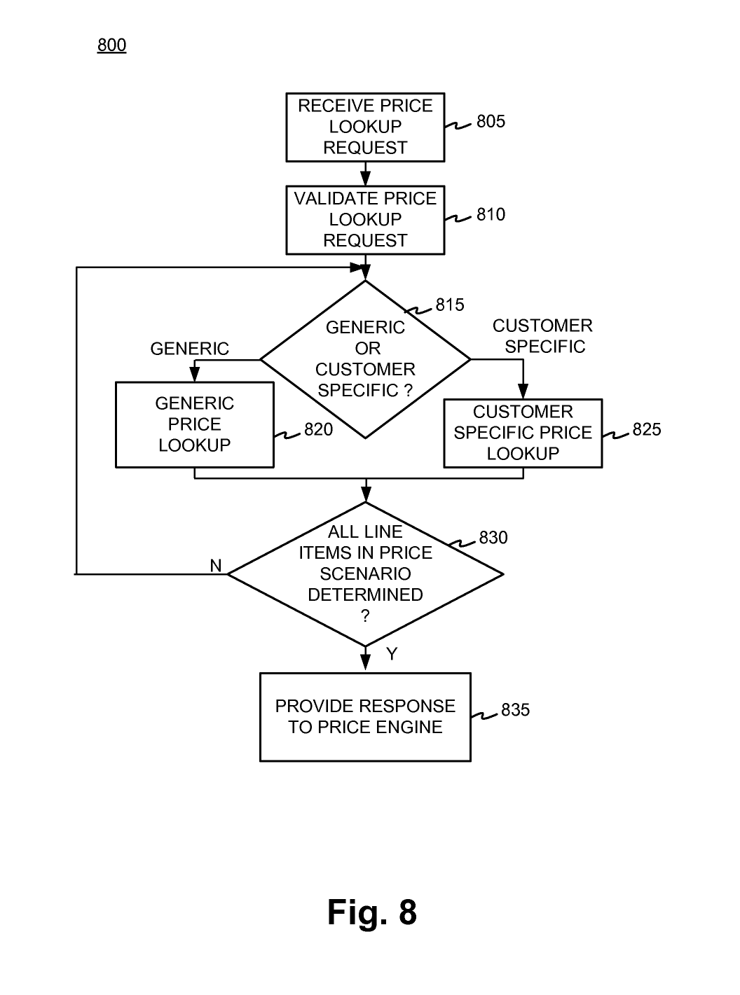

The price lookup service 140 may determine optimal pricing based on the latest price information, and can evaluate combinations of products and/or services to arrive at an optimal price. Price lookup service 140 may have the capability to evaluate very large numbers of combinations (e.g., billions) for various conditions, and arrive at optimal (or if not optimal, at least favorable) prices. Such evaluations may be performed in order to quickly respond to the customer price request. For example, in some embodiments, multiple line items may be processed in approximately one second. In some instances, a price request having a number sites (e.g., twenty sites) and many line items (e.g., a thousand line items) may take approximately one minute (e.g., 66 seconds) to complete. Conventional techniques for manually addressing price requests for a similar number of sites and line items may take days, and thus are much less efficient and may not even be practical in a real-world environment. Further details regarding standard pricing lookup are described below in regards to FIG. 8.

Alternatively, pricing system 100 may determine in Block 515 that dynamic pricing is appropriate, and thus calculate a dynamic price for line item 324 (Block 525). For example, dynamic price determination may be selected when information regarding the service and/or product is available in standard price storage 290. Accordingly, dynamic pricing may calculate a price for line item 324 based on applying a dynamic pricing rule from pricing rules 314 that may be based on a location of the requested service/product, an identity of competitors offering similar services/products, statistical characterizations of past prices, a product type, product features, and/or rate determinants. The pricing is considered dynamic because the pricing may be based on time varying market conditions. Moreover, the aforementioned rate determinants can be considered in calculating a dynamic price, and may include price-influencing factors that may include: location (e.g., zip code, state, country), service/product performance such data access speed, type of product (e.g., Ethernet), known competitor's pricing, prorating, etc. The dynamic prices may further be characterized statistically when analyzing large numbers of data points and combinations thereof.

Once a price (either dynamic or standard) has been determined for a particular line item, pricing system 100 may then determine whether all line items 324 in price scenario 328 have been priced (Block 530). If not, pricing system will loop back to Block 515 to determine pricing for the next line item 328.

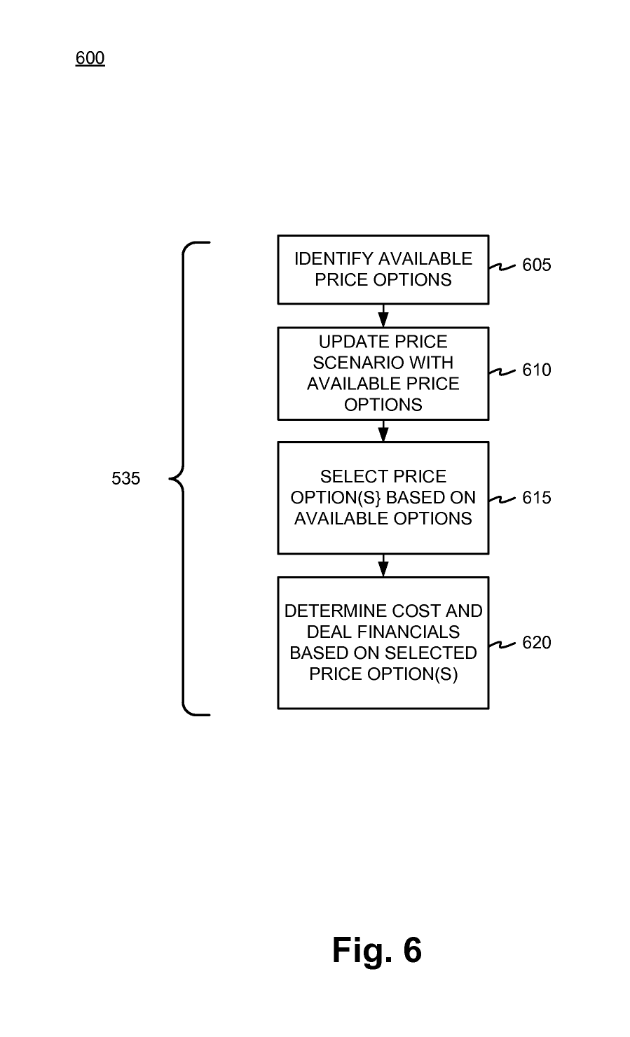

When all of the line items 324 have been priced, then pricing system may determine price option(s) for price scenario 328 (Block 535). Price options may be used for negotiations, and can include promotions and/or discounts, for the requesting customer, which are applied to the overall price scenario. For simplicity, price options are not usually applied on a line item 324 basis. However, some embodiments may do so if useful in negotiations. Price options may be determined based on rules, such as, promotion rules 318 and discount rules 316. Details regarding determining price options for price scenario 328 are described below in regards to FIG. 6.

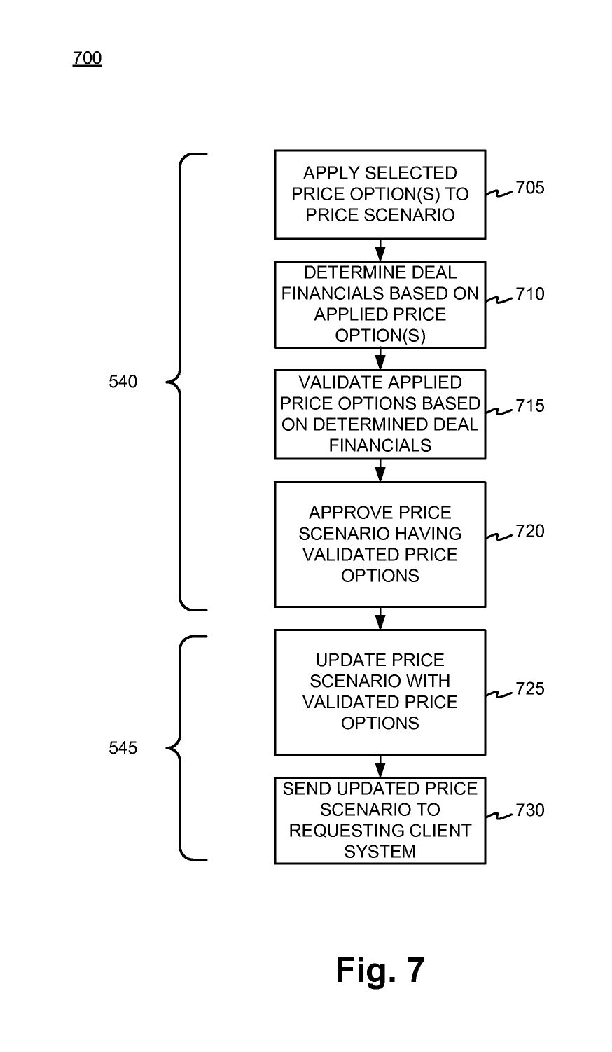

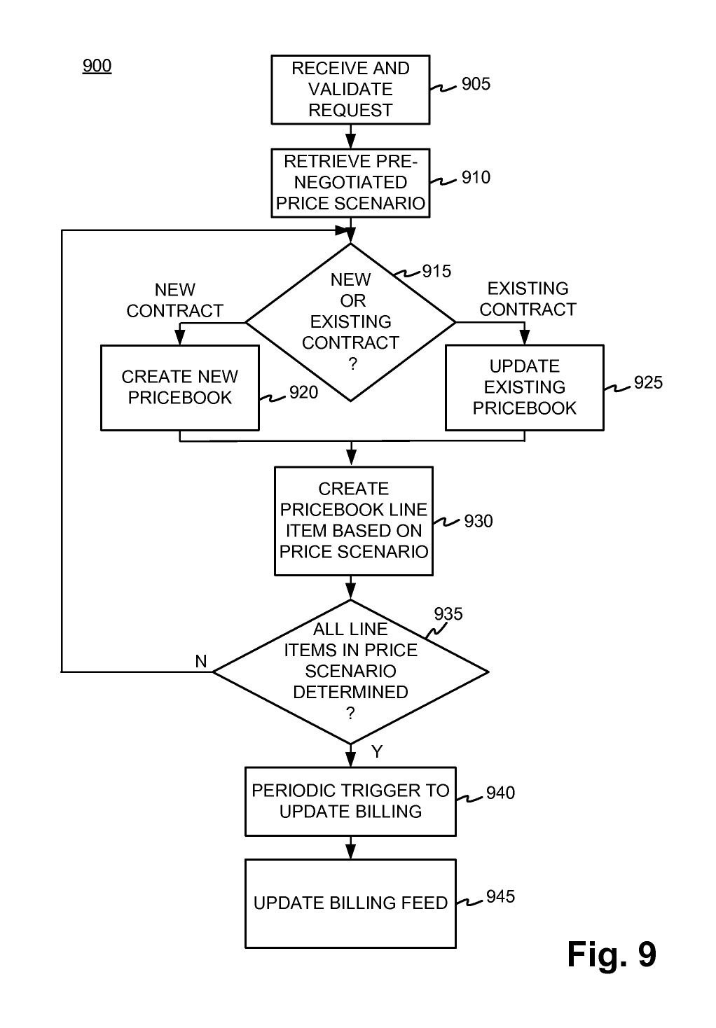

Pricing system 100 may validate the price option(s) determined in Block 535 for price scenario 328 (Block 540). The validation of the price options may be performed automatically by pricing system 100, which are described in more detail below in regards to FIG. 7. Once the price option(s) are validated, pricing system 100 may update price scenario 328 with the validated price option(s), and provide the price scenario 328 to the customer for their approval. The approved price scenario may be stored in price scenario storage 230, and provided to customer pricebook creation/update service 334 for storage in customer pricebook storage 270. As will be discussed in more detail in regards to FIG. 9, the approved price scenario in customer pricebook storage 270 may be used by billing systems for periodic billing of the customer for services and/or installment payments on products. Using the information in customer pricebook storage improves billing accuracy and may be useful for contracts having dynamic pricing (e.g., where the prices may change over time based on certain events, types of products, contractual terms, etc.)

FIG. 6 is a flow diagram illustrating details of an exemplary process 600 for determining price options for price scenario 328. As indicated in FIG. 6, process 600 breaks out details that may be associated with Block 525 (determining price option(s) for price scenario 328) described above in reference to FIG. 5. Pricing system 100 may identify available price options (Block 605). When identifying price options, pricing system 100 may utilize discount rules 316, promotion rules 318 to identify applicable discounts or promotions based on, for example, an identity of the requested product, an identity of the customer, a location of the requested service, a price request type, and/or rate determinants. The rules may further take additional information into account identifying price options. Such information may include, for example, customer type, whether the customer is a new or existing customer, if the customer is renewing a service, the location of the service, the type of contract, the total value of the contract, and/or the possibility of combining services and/or products into bundles. Pricing system 100 may update the price scenario with the available options (Block 610).

Pricing system 100 may select price option(s) from the available price options (Block 615). In an embodiment, the selection from the available price options may be performed manually, wherein pricing system 100 receives input from a user (e.g., a customer service representative (CSR)) who manually selects a desired price option from the available price options. Pricing system 100 may present a user interface that provides the available price options for selection by the CSR, and subsequently receive a command indicating a selection of the selected price option from the available price options. In another embodiment, selecting price options may automatically be performed by pricing system 100 based on, for example, maximizing the profit of the price scenario.

Pricing system 100 may determine cost and deal financials based on the selected price option(s) (Block 620). The deal financials may be used help validate the price scenario with the selected price options(s) as described below in regards to FIG. 7.

FIG. 7 is a flow diagram illustrating details of an exemplary process 700 for validating price options and updating price scenario 328. As indicated in FIG. 7, process 700 breaks out details that may be associated with Blocks 540 and 545 described above in reference to FIG. 5. In order to validate the price option(s), pricing system may apply the selected price option(s) to the price scenario (Block 705). In an embodiment, pricing system 100 may apply applicable discount(s) and/or promotion(s) based on a rule that considers the identity of the customer, the location of the service, the price request type, and/or the rate determinants. Pricing system 100 may then determine deal financials based on the applied price option(s) (Block 710). The deal financials may provide metrics (e.g., price floor, margin, profit, etc.) as to whether the price scenario with the applied options is reasonable from a business perspective. Pricing system 100 may validate the applied price option(s) based on the deal financials (Block 715). This validation may be performed based on rules, such as, for example, margin and pricing policy rules 320. Once price option(s) have been validated, the price scenario with the selected price option(s) may be approved (Block 720). The approval may be performed automatically by pricing system 100, and may be subject to manual review and/or approval if required (including the type and/or level of escalation, if applicable). In some circumstances, the options may be rejected, and reasons for the rejection may be provided. Pricing system 100 may update the approved price scenario with the validated price option(s) (Block 725), and subsequently send the updated price option to customer system 110 for final approval by the customer (Block 730).

FIG. 8 is a flow diagram illustrating an exemplary process 800 for performing a standard price lookup. Process 800 may be performed by standard price lookup service (SPLS) 140. SPLS 140 may initially receive a standard price lookup request for one or more line item(s) 324 (Block 805). SPLS 140 may validate the standard price lookup request (Block 810). The validation may include validating based on the service and/or product types, and any associated features, and/or rate determinants based on, for example, service and/or product catalog information, such as, for example, enterprise catalog data. For each line item 324 received, SPLS 140 may perform a price lookup as shown in Blocks 815 through 830 in FIG. 8. In more detail, at Block 815, SPLS 140 may decide whether to perform a generic or customer specific price lookup (Block 815) for a line item. A generic price lookup using a price repository stored in standard price storage 290 may be performed when the customer is new or the customer identity is unknown or inconsequential (Block 820).

A customer specific price lookup may be performed if the customer has an existing contract, where the prices may be obtained from customer pricebook storage 270, based on the customer's identity (Block 825). The generic price lookup and/or the customer specific price lookup may be a function of predefined price template definitions and template precedence. The price templates may describe a group of attributes for a service and/or product which may act as determinants defining price. The templates may be hierarchically organized (e.g., having parents and children) and may describe attributes for service/product features. Some features may have more than one template and may have an established priority based upon context. For example, in determining a price for data services in one geographic region, data speed may be classified as the top priority. In another geographic region, the location of the service and the technology type may be top priorities in pricing, Templates may include, for example, information regarding country code, state code, technology type, technology performance (e.g., data speed).

Once a price (either generic or customer specific) has been determined for a particular line item, SPLS 140 may then determine whether the prices for all line items 324 in the received request have been determined (Block 830). If not, pricing system will loop back to Block 815 to determine a price for the next line item 328. When all of the line items 324 have been priced, then SPLS 140 may provide the results in a response to price engine 120 (Block 835).

FIG. 9 is a flow diagram illustrating an exemplary process 900 for creating or updating a customer pricebook. Process 900 may be performed by customer pricebook creation/update service (CPCUS) 334. New pricebooks may be created for new customers and/or new contracts. Existing price books may be updated for changes to existing contracts and/or price scenarios.

CPCUS 334 may initially receive a request to update or create a customer pricebook information and validate the request (Block 905). CPCUS 334 may retrieve a pre-negotiated price scenario (Block 910). The validation may include validating against a pre-negotiated price scenario by retrieving the price scenario details from the price engine 120. For each line item 324 received in the request, CPCUS 334 may perform a price lookup as shown in Blocks 915 through 930 in FIG. 9. In more detail, at Block 915, CPCUS 334 may determining whether the request is associated with a new or existing contract for a line item (Block 915). CPCUS 334 may create a new pricebook upon determining the request is associated with a new contract (Block 920). Alternatively, CPCUS 334 may update an existing pricebook upon determining the request is associated with an existing contract (Block 925). CPCUS 334 may then create a pricebook line item based on the price scenario 328 (Block 930).

Once the appropriate pricebook operations (Block 920 or Block 925) have been completed for a particular line item 324, CPCUS 334 may then determine whether all line items 324 in the received request have been processed (Block 935). If not, CPCUS 334 will loop back to Block 915 to perform the appropriate pricebook operations (Block 920 or Block 925) for the next line item 328. When all of the line items 324 have been processed, then CPCUS 334 may generate a periodic trigger to update a billing system with the customer pricebook information (Block 940). Once triggered, CPCUS may update the billing feed, which may be provided to the customer (Block 945). Updating the billing feed may further include providing pricing and contract information to a billing system and/or a revenue assurance system.

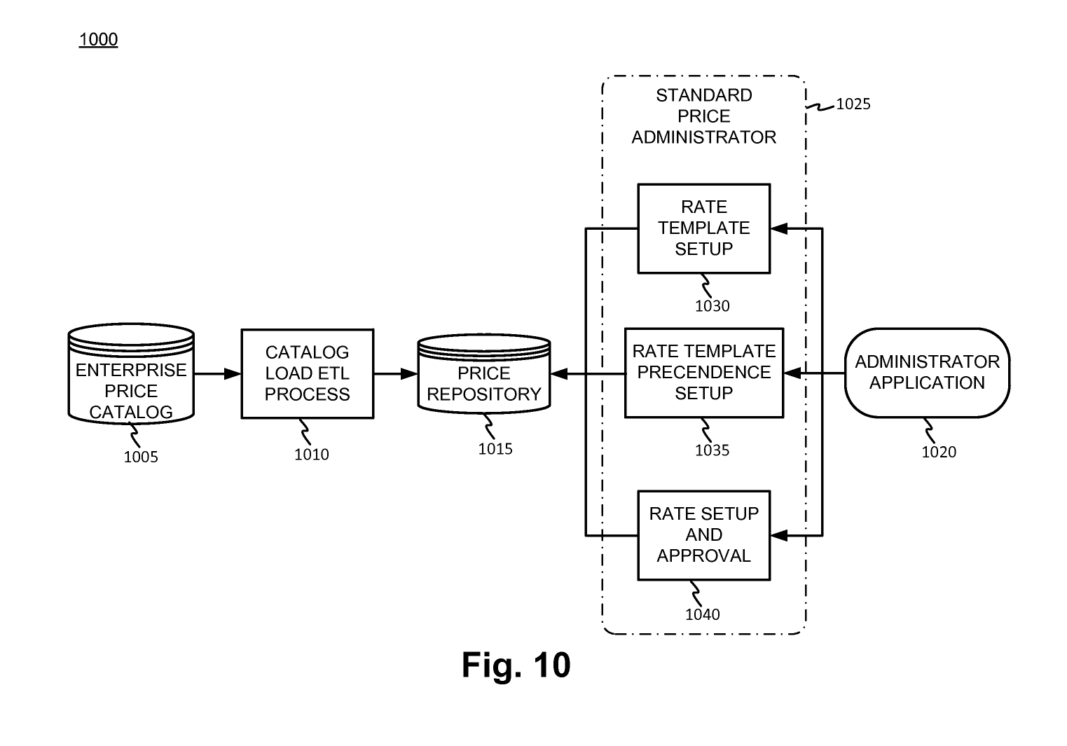

FIG. 10 is a flow diagram illustrating an exemplary process 1000 for setting up and administering a standard price repository which may be used in standard price storage 290 for pricing of line items. Process 1000 may be performed by standard price service (SPS) 280 (which also is responsible for standard price lookup service 140). Initially, SPS 280 may perform an extract, transform, and load (ETL) of catalog data from one or more enterprise price catalogs 1005 (Block 1010). The catalog data may provide up-to-date price information to price repository 1015, which may contain millions of price points that are maintained for different configurations and market conditions. Metadata may also be established by defining prices for each SKU based on certain conditions and/or combination of rate determinants.

Using a standard price administrator 1025, an administrator using an administrator application 1020 may set-up and organize the metadata in price repository 1015. For example, the administrator may associate SKU-based prices with various conditions, features, or combinations thereof. The pricing in price repository 1015 may be associated with dates, so price engine 120 may have context as to how recent pricing is for a particular SKU item. Once completed, the price repository may be used to build the standard price data stored in standard price storage 290.

Administrator application 1020 may further setup price templates 1030 (which may also be referred to as “rate templates” for periodic charges for services) based on service/product features and rate determinants. One feature may have multiple templates. Accordingly, price template precedence setup 1035 may establish a precedence for templates by ranking them based on input provided by the administrator. The precedence established an order for the lookup process based on different contexts and product features. Finally, rate setup and approval 1050 may, using input from the administrator, obtain multiple levels of approvals for the prices and templates stored in price repository 1015. Template information provided by price template setup 1030, and template precedence information provided by price template precedence setup 1035 may be stored in price repository 1015.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while a series of blocks has been described with respect to FIGS. 5-10, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code. It being understood that software and control hardware can be designed to implement these aspects based on the description herein.

Further, certain portions of the invention may be implemented as a “component” or “system” that performs one or more functions. These components/systems may include hardware, such as a processor, an ASIC, a FPGA, or other processing logic, or a combination of hardware and software.

To the extent the aforementioned embodiments collect, store or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the invention unless explicitly described as such. Also, as used herein, the article “a” and “one of is intended to include one or more items. Further, the phrase “based on” is intended to mean “based, at least in part, on” unless explicitly stated otherwise.

What is claimed is:

1. A method, comprising:
receiving a price request for a telecommunication service from a customer system;
creating a price scenario for the telecommunication service based on the request, wherein the price scenario includes a plurality of line items;
deciding whether to calculate a standard price or a dynamic price for each line item;
calculating a price for each of the line items in the price scenario in response to the deciding;
determining at least one price option for the price scenario;
validating the at least one price option for the price scenario;
updating the price scenario with the at least one validated price option; and
providing the updated price scenario to the customer system.

2. The method of claim 1, wherein deciding whether to calculate the standard price or the dynamic price comprises:
identifying a provider for a service associated with the price request.

3. The method of claim 1, wherein calculating the standard price comprises:
looking up a price based on a price request type, wherein the price request type includes one of a Right to Buy, a Transaction, a Quote to Order, a Next Order, and a Move, Change and Disconnect.

4. The method of claim 1, wherein calculating the dynamic price comprises:
applying a dynamic pricing rule based on at least one of a location of the service, an identity of competitors offering similar services, statistical characterizations of past prices, a product type, product features, and rate determinants.

5. The method of claim 1, wherein determining at least one price option comprises:
identifying available price options;
updating the price scenario with the available price options;
selecting at least one price option based on the available price options; and
determining cost and deal financials based on the at least one selected price option.

6. The method of claim 5, wherein identifying available price options further comprises:
identifying at least one applicable discount or promotion based on at least one of an identity of a requested service or product, an identity of the customer, a location of the requested service, a price request type, or rate determinants.

7. The method of claim 5, wherein selecting at least one price option comprises:
presenting a user interface that provides the available price options for selection; and
receiving a command indicating a selection of the at least one selected price option from the available price options.

8. The method of claim 5, wherein validating the at least one price option further comprises:
applying the at least one selected price option to the price scenario;
determining deal financials based on the at least one applied price option;
validating the at least one applied price option based on the determined deal financials;
approving the price scenario having the at least one validated price option;
updating the approved price scenario with the at least one validated price option; and
sending the updated price scenario to the customer system.

9. The method of claim 8, wherein applying the at least one determined price option comprises:
applying at least one applicable discount or promotion based on a rule that considers at least one of an identity of a customer, a location of the service, a price request type, or rate determinants.

10. The method of claim 1, wherein calculating a standard price comprises:
receiving a standard price lookup request for at least one line item;
validating the standard price lookup request;
deciding whether to lookup a generic price or a customer specific price for the at least one line item; and
looking up a price based for the standard lookup request based on the deciding.

11. The method of claim 10, wherein validating the standard price lookup comprises:
comparing at least one of product types, product features, or rate determinants associated with the standard price lookup request against enterprise catalog data.

12. The method of claim 10, wherein looking up a price further comprises:
determining the price based on predefined price template definitions and template precedence.

13. The method of claim 1, wherein updating the price scenario comprises:
receiving a request to update or create a customer pricebook information;
validating the received request;
determining whether the request is associated with a new or existing contract; and
creating a new pricebook upon determining the request is associated with a new contract;
updating an existing pricebook upon determining the request is associated with an existing contract; and
creating, for each line item, pricebook line items based on price scenario line items;
periodically updating billing data for bill generation; and
updating billing feed provided to a customer with updated billing data.

14. The method of claim 13, wherein updating the billing feed further comprises:
providing pricing and contract information to at least one of a billing system or a revenue assurance system.

15. A device, comprising:
a memory to store instructions; and
a processor, coupled to the memory, configured to execute the instructions stored in memory to:
receive a price request for a telecommunication service from a customer system,
create a price scenario for the telecommunication service based on the request, wherein the price scenario includes a plurality of line items,
decide whether to calculate a standard price or a dynamic price for each line item,
calculate a price for each of the line items in the price scenario in response to the deciding,
determine at least one price option for the price scenario,
validate the at least one price option for the price scenario,
update the price scenario with the at least one validated price option, and
provide the updated price scenario to the customer system.

16. The device of claim 15, wherein the instructions to decide whether to calculate the standard price or the dynamic price comprises instructions to:
identify a provider for a service associated with the price request.

17. The device of claim 15, wherein the instructions to determine at least one price option comprises instructions to:
identify available price options;
update the price scenario with available price options;
select at least one price option based on the available price options; and
determine cost and deal financials based on the at least one determined price option. cm 18. The device of claim 15, wherein the instruction to validate the at least one price option comprises instructions to:
apply the at least one determined price option to the price scenario;
determine deal financials based on the at least one applied price option;
validate the at least one applied price option based on the determined deal financials;
approve the price scenario having the at least one validated price option;
update the approved price scenario with the at least one validated price option; and
send the updated price scenario to the customer system.

19. The device of claim 15, wherein the instruction to calculate a standard price comprises instructions to:
receive a standard price lookup request for at least one line item;
validate the standard price lookup request;
decide whether to lookup a generic price or a customer specific price for the at least one line item; and
look up a price based for the standard lookup request based on the deciding.

20. A non-transitory computer-readable medium comprising instructions, which, when executed by a processor, cause the processor to:
receive a price request for a telecommunication service from a customer system;
create a price scenario for the telecommunication service based on the request, wherein the price scenario includes a plurality of line items;
decide whether to calculate a standard price or a dynamic price for each line item;
calculate a price for each of the line items in the price scenario in response to the deciding;
determine at least one price option for the price scenario;
validate the at least one price option for the price scenario;
update price scenario with the at least one validated price option; and
provide the updated price scenario to the customer system.
